(19) United States
(12) Patent Application Publication
(10) Pub. No.: US 2014/0066579 A1
(43) Pub. Date: Mar. 6, 2014

(54) POLYALKENYL SUCCINIMIDES AND USE THEREOF AS DISPERSANTS IN LUBRICATING OILS

(71) Applicants: Riccardo RAUSA, San Donato Milanese (Milan) (IT); Orazio Pianta, Santo Stefano Ticino (IT); Alberto Roselli, Paullo (Milan) (IT); Mauro Anzani, Milan (IT)

(72) Inventors: Riccardo RAUSA, San Donato Milanese (Milan) (IT); Orazio Pianta, Santo Stefano Ticino (IT); Alberto Roselli, Paullo (Milan) (IT); Mauro Anzani, Milan (IT)

(73) Assignee: ENI S.P.A., Rome (IT)

(21) Appl. No.: 14/073,057

(22) Filed: Nov. 6, 2013

Related U.S. Application Data
(62) Division of application No. 12/669,693, filed on Apr. 21, 2010, now abandoned.

(30) Foreign Application Priority Data
Jul. 18, 2007 (IT) MI2007A001445

(51) Int. Cl. C08F 8/46

(52) U.S. Cl. CPC C08F 8/46
USPC 525/371

(57) ABSTRACT

Polyalkenyl succinimides which can be obtained with a process which comprises:
a. reacting a reactive medium-high molecular weight polyalkene with maleic anhydride at a temperature higher than 180° C.;
b. carrying out the reaction thermally for a time sufficient for having a conversion of the terminal vinylidene groups higher than 10%;
c. completing the thermal reaction in the presence of a reaction accelerator consisting of a Lewis acid;
d. reacting the reaction product of step (c) with an amine which has at least one primary aminic group capable of forming an imide group.

### CROSS-REFERENCE TO RELATED APPLICATIONS

This application is a Divisional of U.S. application Ser. No. 12/669,693, filed Apr. 21, 2010, which is a 371 of PCT/EP08/05629 filed Jul. 8, 2008, which claims priority to Italian Application No. MI2007A001445 filed Jul. 18, 2007; of which all of the disclosures are incorporated herein by reference in their entireties.

The present invention relates to polyalkenyl succinimides and the use thereof as dispersants in lubricating oils.

More specifically, the present invention relates to medium-high-molecular weight polyalkenyl succinimides and the use thereof as dispersants in lubricating oils for internal combustion engines.

In the present description, all the conditions indicated in the text should be considered as preferred conditions, even if not expressly declared.

It is known that lubricating oils for internal combustion engines contain numerous additives for reducing or controlling deposits, reducing friction, wear, etc. The function of dispersants in lubricating oils is to maintain insoluble materials, such as, for example, carbon deposits (soot) and sludge formed by oxidation or due to other complex mechanisms, dispersed in oil. This prevents their flocculation and consequently their precipitation, which would cause serious damage to the engine.

Furthermore, in diesel engines, dispersants can efficiently contrast the increase in viscosity or the gelification of the lubricant caused by the formation of complex structures which are formed by soot particles which, in the absence of additives, give rise to strong mutual interactions with consequent agglomeration.

Among the known detergent additives, some of the most effective are polyalkenyl acylating agents possibly containing an imide group. These compounds are generally prepared either by classical synthesis, with the use of chlorinated intermediates, or by direct thermal reaction of a polyalkene, characterized by double terminal bonds of the vinylidene type, with an enophile, at a temperature higher than 150° C., generally higher than 200° C., possibly followed by the reaction with an amine having at least one primary aminic group which can react to form the imide group. Examples of processes for the preparation of these polyalkenyl acylating agents are provided in U.S. Pat. Nos. 3,172,892, 3,912,764, 4,086,251 and 4,152,499.

In the case of products obtained via a thermal process, however, if a chlorine-free product is desired, the preparation processes of the known art are characterized, when carried out at relatively low temperatures (around 200° C.), by the drawback of having long reaction times and rather low yields and, in any case, they provide a product with a low functionalization degree.

The Applicant has now found a dispersant additive for lubricating oils selected from the group of polyalkenyl succinimides, which have a high functionalization degree which makes it particularly effective for this function, as illustrated in the enclosed examples.

An object of the present invention, therefore, relates to polyalkenyl succinimides produced starting from polyalkenyl succinanhydrides having a number average molecular weight, Mn, ranging from about 1,400 to 6,300 and a functionalization degree (FD) higher than 1, generally ranging from 1.30 to 2.50. The functionalization degree is calculated according to the procedure described in U.S. Pat. No. 4,952,328.

Alternatively, the functionalization degree of the polyalkenyl succinanhydrides can be calculated more directly and specifically, via H¹-NMR (FD_{NMR}), by determining, in the reaction mixture, the formation of the various anhydride adducts, using the following formula:

FD_{NMR}: (A/2+B+2C+2D)/(A/2+B+C+D)

wherein A and B are the areas of mono-functionalized anhydrides and C and D are those of bis-functionalized anhydrides, calculated from the resonances attributed in the NMR spectra, according to what reported in the literature (Tessier M., Marechal E.; J. Polym. Sci., Part A: Polym. Chem. 1998; 26: 785-810). In this case the FD_{NMR} of the products can vary from 1 to 2, preferably from 1.3 to 1.9.

More specifically, an object of the present invention relates to polyalkenyl succinimides which can be obtained with a process which comprises:
a. reacting a reactive polyalkene having a number average molecular weight, Mn, ranging from 1,300 to 6,000 and having a terminal vinylidene groups content higher than or equal to 30%, with an enophile selected from maleic anhydride or maleic acid at a temperature higher than 180° C.;
b. carrying out the reaction thermally for a time sufficient for having a conversion of the terminal vinylidene groups higher than 10%;
c. completing the reaction in the presence of a reaction accelerator consisting of a Lewis acid selected from a tin, zinc, aluminum or titanium halides having the formula MX_{y}, wherein M is the metal, X represents a halide such as chlorine, bromine or iodine, and y varies from 2 to 4. The metallic halide MX_{y} can also comprise a number of crystallization water molecules ranging from 1 to 5;
d. reacting the reaction product of step (c), the polyalkenyl succinanhydride, with an amine which has at least one primary aminic group capable of forming an imide group.

According to the present invention, the reagent mixture of the first reaction phase (a)-(b) is introduced into a reactor, suitable for performing batch reactions, in any convenient way before heating to the reaction temperature. The reagents, for example, can be charged contemporaneously or sequentially in any order or pre-mixed in a mixing container and then transferred to the reaction vessel. Alternatively, the reaction of phase (a)-(b) can be carried out in continuous.

The reaction is then completed (phase c) in the presence of a reaction accelerator consisting of the Lewis acid selected from a tin, zinc, aluminum or titanium halide. The reaction accelerator is preferably tin chloride SnCl₂.2H₂O.

The reaction accelerator is added to the reaction mixture when the conversion of the terminal vinylidene groups of the reactive polyalkene ranges from 15 to 90%, preferably from 30 to 80%. The accelerator is added to the reaction mixture in quantities corresponding to a molar percentage concentration, referred to the reactive double bonds of the polyalkene, ranging from 0.2 to 1.5%, preferably from 0.5 to 1.1%.

The reaction of phases (a)-(b) and (c) can be carried out in a solvent and in this case the solvent is a mineral oil able to solubilise reactants and reaction products which can be recovered after bringing the reaction mixture, at the end of the reaction, to room temperature, and after subjecting it, or not, to filtration. The products recovered are subsequently used for the step (d) of the reaction. Alternatively, step (d) can be performed in the same reaction environment as phases (a)-(c).

Phases (a)-(c) can also be carried out in the absence of solvent, subsequently carrying out phase (d) as described above.

The reactive polyalkenes differ from the conventional polyalkenes in the content of terminal vinylidene groups. A polyalkylene chain which has a terminal vinylidene group can be represented by the formula:

POLY-C(R)═CH₂

wherein R is an alkyl group, whose identity depends on the monomeric unit from which the polyalkene is obtained (for example R is a methyl group for polyisobutene) whereas POLY represents the remaining part of the polyalkenyl chain. Reactive polyalkenes are those which have a content of terminal vinylidene groups equal to at least 35%, preferably equal to at least 40%, more preferably ranging from 50 to 95%.

The polyalkenes according to the present invention are generally reactive homopolymers of α-olefins or co-polymers of α-olefins, such as, for example, the ethylene-α-olefin copolymer. Preferred α-olefins according to the present invention are those, linear or branched, having the general formula CH₂═CHR′ wherein R′ represents a linear or branched alkyl radical, containing from 1 to 10 carbon atoms.

Preferred polyalkenes according to the present invention are reactive polyisobutene (PIB) and polybutene-1 with a content of terminal vinylidene groups preferably of at least 45%, for example between 55 and 99%, preferably from 55 to 90%. Methods for the preparation of reactive polyisobutene or polybutene-1 are described, for example, in U.S. Pat. Nos. 4,152,499, 4,605,808, 5,674,955 and in the international patent application WO 01/19873.

Furthermore, the polyalkenes according to the present invention have a number average molecular weight, Mn, measured, for example, by means of GPC (Gel Permeation Chromatography), osmometry, proton NMR or carbon-13 NMR, ranging from 1,300 to 6,000, for example from 1,500 to 4,000, preferably from 2,000 to 3,000.

Particularly preferred polyalkenes are reactive polyisobutene (PIB) and polybutene-1, mentioned above, and having an average molecular weight Mn ranging from 1,900 to 2,400.

The formation of the intermediate polyalkenyl succinanhydride is obtained through the reaction between the reactive polyalkene and an “enophile”, preferably maleic anhydride or the corresponding acid. Analogous intermediate products, however, obtained from other anhydrides/unsaturated polycarboxylic acids, used alone or mixed with the maleic anhydride/maleic acid, fall within the scope of the present invention. Examples of these unsaturated polycarboxylic acids are fumaric acid, itaconic acid, and their corresponding anhydrides or their corresponding C₁-C₄ alkyl esters.

The reaction between the reactive polyalkene and the enophile takes place at a temperature ranging from 180 to 300° C., preferably from 190 to 250° C. and even more preferably at about 200° C., at room pressure or under an inert gas, such as nitrogen, at pressures ranging from 0.1 to 1 MPa.

The reactive polyalkylene/enophile molar ratios generally range from 1:0.9 and 1:3, preferably from 1:1.3 to 1:2.5, for example from 1:1.5 to 1:2.4.

The polyalkenyl succinanhydride is reacted with an amine, or a polyamine, having at least one primary amine group capable of forming an imide group, selected from mono-amines such as methyl amine, 2-ethylhexyl amine, n-dodecyl amine, stearyl amine, etc. or from polyamines such as, for example, propylene diamine. Particularly preferred are polyalkylene polyamines or polyamines having the general formula

H₂N(CH₂CH₂NH)ₙH

wherein n is an integer ranging from 1 to 10. Examples of these polyamines are ethylene diamine, diethylene triamine (DETA), triethylene tetramine (TETA), tetraethylene pentamine (TEPA), pentaethylene hexamine (PEHA) and higher polyamines (HEPA), etc.

The reaction between the polyalkenyl succinanhydride and the polyamine, for the formation of imides or, in particular, polyisobutenyl succinimides (PIBSI), takes place at a temperature ranging from 100 to 200° C., preferably from 140 to 170° C., at atmospheric pressure, even if it is possible to operate at pressures higher or lower than atmospheric pressure.

The water present in the system or generated during the reaction is preferably removed by stripping under nitrogen. The removal can be facilitated by operating under conditions of reduced pressure.

The relative quantities of anhydride and polyamines are selected so that the ratio between the equivalents of succinic anhydride and polyamine (or amine) generally ranges from 0.5 to 2. In this way, by regulating the stoichiometry of the reaction, mono- or disuccinimides can be obtained.

The term imide, as used in the present description and claims, refers to the complete reaction product between the polyamine and the acylating agent (for example polyisobutenyl succinanhydride or PIBSA) which can comprise amides, amidines and possible saline species which can be formed from the reaction between the anhydride group and amine or polyamine.

The imidation reaction can take place in the same reaction environment as the anhydride, or the polyalkenyl succinanhydride can be recovered with the known methods, for example by gear pumps, and can be transferred and reacted separately with the amine. The reaction can be carried out in the presence or absence of a solvent (mass imidation) and in the latter case the solvent can be added at the end. In this way, the final succinimide can be filtered, if necessary, moved, stored or more advantageously mixed with other components.

Solvents suitable for the purpose are mineral or synthetic oils having a viscosity suitable for being used in internal combustion engines. Mineral oils for use as diluent according to the present invention include paraffinic oils, naphthenic oils and other oils normally used as components of lubricating oils. Synthetic oils can include mixtures of hydrocarbons consisting, for example, of polymers of alpha-olefins having a suitable viscosity, for example liquid hydrogenated oligomers of C₆-C₁₂ alpha-olefins, such as trimers of 1-decene. Blends of synthetic oils can also be used.

The polyalkenyl succinimides, object of the present invention, can be used as dispersant additives for lubricating oils or they can be used together with other components in “additive concentrates” or “packages” to be added to the lubricating oil whose performances are to be improved. The final dispersant is a highly desirable alternative with respect to analogous dispersants produced according to the classical synthesis process starting from the synthesis of anhydrides by means of chlorinated intermediates.

Furthermore, the polyalkenyl succinimides, object of the present invention, generally have a higher functionalization degree than that obtained with the “classical” thermal reaction, which makes them more reactive with respect to the dispersants obtained with non-catalytic thermal processes.

A further object of the present invention relates to hydrocarbon compositions comprising polyalkenyl succinimides prepared as described above.

In particular, a further object of the present invention relates to hydrocarbon lubricating compositions comprising:
i. one or more lubricant base oils having a viscosity ranging from 3 to 15 cSt at 100° C., preferably from 5 to 10 cSt at 100° C., suitable for being used as automotive lubricants; and
ii. from 0.1 to 15% by weight with respect to the total composition, preferably from 1 to 10%, of a polyalkenyl succinimide, deriving from a polyalkenyl succinanhydride having a number average molecular weight Mn ranging from about 1,400 to 5,300 and a functionalization degree (FD) higher than 1.0 or FD_{NMR} ranging from 1 to 2, obtained with the process comprising steps (a)-(d) described above.

The hydrocarbon composition object of the present invention can also contain conventional additives used in automotive lubricants such as detergents, friction-modifiers, antioxidants, etc.

Particularly preferred in the hydrocarbon compositions of the present invention are polyisobutenyl succinimides, deriving from polyisobutenyl succinanhydrides having a number average molecular weight Mn ranging from 2,000 to 3,000 and a functionalization degree (FD) higher than 1.0 or FD_{NMR} ranging from 1 to 2, obtained with the process comprising steps (a)-(d) described above.

Non-conventional or synthetic mineral oils, belonging to groups I-V according to the API (American Petroleum Institute) classification, used individually or in blends, fall within the definition of lubricating base oils and are preferred.

The mineral oils can consist of mixtures of paraffinic oils, naphthenic oils and other oils normally used as components of automotive engine oils.

The synthetic oils can include, for example, hydrocarbon mixtures consisting of polymers of alpha-olefins having a suitable viscosity, for example liquid hydrogenated oligomers of C₆-C₁₂ alpha-olefins, such as trimers of 1-decene, etc.

The lubricating base oils can be used alone or in blends.

The present invention is now illustrated for illustrative and non-limiting purposes by the following examples.

### EXAMPLE 1

### Synthesis of Polyisobutenyl Cuccinanhydride (PIBSA)

In a generic experiment, 100 g of PIB (Glissopal 2,300, BASF; Mn 2,300) are introduced into a 250 mL cylindrical glass reactor, equipped with a mechanical stirrer and a reflux condenser.

The reactor is flushed with nitrogen, under stirring, until a temperature of 110° C. is reached. After 30 minutes, 6.39 g of maleic anhydride (MA) are added, under nitrogen, and the mixture is heated to 200° C.

After at least 50% of the reaction has been completed, SnCl₂.2H₂O is added, under stirring, and the reaction is kept under stirring for twenty-one hours. The temperature is then lowered to 160° C. and the unreacted enophile is stripped under vacuum (0.2 mm Hg).

The weight conversion degree of the reaction was evaluated, by difference, by quantifying the weight o unreacted polyisobutylene after its separation from the reaction mixture. A weighed quantity of polyisobutenyl succinanhydride (PIBSA), dissolved in n-heptane, is eluted through a chromatographic column, containing silica gel. The eluted phase, containing only unreacted PIB, is then evaporated, dried under vacuum (0.2 mm Hg) and weighed.

The functionalization degree (FD), expressed as grafted moles of succinic anhydride per mole of reacted polymer, was determined according to the procedure described in U.S. Pat. No. 4,952,328, after determining the acidity of the PIBSA, by titration according to what is described in the method ASTM D 664

The NMR functionalization degree (FD_{NMR}) was calculated after determining the adducts present in the PIBSA according to the method described in literature: Tessier M., Marechal E. J. Polym. Sci., Part A: Polym. Chem. 1988; 26; 785-810.

Table 1 shows the yields and the functionalization degree of the products, obtained at various times, in the presence and absence of catalyst.

TABLE 1

| | | | | reac. | | | |
|---|---|---|---|---|---|---|---|
| PIB | T | Cat. | | time | Yield | | |
| Mn | (° C.) | (mol. %) | PIB/MAH | (hrs) | (w %) | FD | FD_{NMR} |
| 2300 | 200 | 0.00 | 1/1.5 | 7 | 67.5 | 1.62 | 1.07 |
| | | | | 10 | 71.3 | 1.73 | 1.11 |
| | | | | 12 | 73.0 | 1.76 | 1.18 |
| | | | | 21 | 75.8 | 1.76 | 1.20 |
| 2300 | 200 | 0.5 (1) | 1/1.5 | 7 | 69.7 | 1.65 | 1.05 |
| | | | | 10 | 72.8 | 1.92 | 1.47 |
| | | | | 12 | 74.3 | 1.84 | 1.49 |
| | | | | 21 | 77.1 | 2.05 | 1.52 |

(1) Catalyst added after partial conversion of PIB

### Synthesis of Polyisobutenyl Succinimide

The polyisobutenyl succinimide (PIBSI) is prepared by introducing 100 g of polyisobutenyl succinanhydride (PIBSA) into a jacketed cylindrical glass reactor, equipped with a mechanical stirrer, a lower drainage valve and a reflux condenser. After the addition of 110 g of base oil SN150, 7.23 g of HEPA are added at a temperature of 130° C., under a nitrogen blanket, the temperature is increased to 165° C. and the reaction is continued for about two hours. The water formed is stripped away by applying, for an hour, a nitrogen flow from the bottom of the reactor.

### EXAMPLE 2

### Evaluation of the Products: Spot Test

The evaluation of the dispersing properties of the products obtained in example 1, can be performed by means of the “spot test”. In this test, a lubricant formulated with 8% by weight of the dispersant to be analyzed, is mixed, at room temperature, with synthetic sludges and stirred twice, by using a turbine, at about 20,000 rev/min for 30 seconds with a 15 seconds interval.

After heating to 250° C. for 10 minutes, the dispersion thus obtained is left to cool to room temperature. An aliquot of the dispersion, collected by means of a pipette, is deposited on a filter paper sheet, prepared in advance and fixed to a frame, forming a more or less circular spot. The filter paper is then placed, for 24 hours, in a thermostatted oven set at 40° C.

The evaluation of the dispersing properties of the formulate under examination is carried out, performing duplicate tests, by analyzing and quantifying the spot produced on the filter paper. This is obtained by determining a coefficient, ID %, calculated by normalizing to 100 the ratio between the inner and outer diameters of the spot halos according to the following relationship:

ID %=(ID/ED)·100

wherein ID and ED are respectively the inner and the outer spot diameters. The higher the ratio under examination, the greater the dispersing efficacy of the oil, as the extension of the inner diameter is related to the dispersion of the sludge.

Table 2 shows the results obtained with a SAE 5W40 lubricating oil formulated with the PIBSI of example 1 at 8% by weight. The results are compared with those obtained with a commercial oil of analogous SAE grade.

The data of the laboratory test, demonstrate the dispersant efficacy, with respect to the sludge, of the additive object of the present invention when compared with the commercial product.

TABLE 2

| | | Stain 1 | | | Stain 2 | | | |
|---|---|---|---|---|---|---|---|---|
| | | ID | ED | | ID | ED | | Average |
| Sample | SAE | (cm) | (cm) | ID % | (cm) | (cm) | ID % | ID % |
| commercial | 5w40 | 1.5 | 4.0 | 37.5 | 1.8 | 4.5 | 40.0 | 38.8 |
| oil | | | | | | | | |
| oil + | 5w40 | 1.9 | 3.4 | 56.0 | 1.8 | 3.2 | 56.3 | 56.1 |
| PIBSI | | | | | | | | |

Results Obtained with the CEC L-93-04 Engine Test.

The CEC L-93-04 engine test (dispersion at medium temperature), was used for evaluating the dispersing properties of an oil after the addition of the dispersant of example 1.

The above mentioned method is part of the ACEA 2004 (Association des Constructeurs Europeen d'Automobiles) specifications, and simulates the behaviour of passenger car diesel engines under high-speed highway service.

The test is carried out using a Peugeot diesel engine DV4TD, equipped with a “common rail” injection system, which is run continuously for 120 hours within a standard procedure. The performances of the lubricant are evaluated at a 24 hours time interval, determining at different times, the increase in the kinematic viscosity at 100° C. with respect to the content of carbonaceous residue (soot). The values of these parameters are used to calculate, by interpolation, the absolute viscosity increase found in correspondence with a 6% soot content. This value is then compared with the equivalent value found for a reference oil (RL223).

### Pass/Fail Criteria

A positive result (PASS) is obtained when the viscosity percentage increase of the oil under examination, determined at a 6% soot concentration does not exceed 60% of the analogous value obtained with the reference oil.

The polyisobutenyl succinimides prepared according to example 1, were introduced in a suitable “package” containing other additives and added to an appropriate base oil in such a way that a SAE 5W40 lubricant, according to the SAE J300 classification, with a final 8% (wt/wt) dispersants concentration was obtained.

Table 3 shows the results obtained in the DV4TD test.

TABLE 3

| Formulate | | A3/B3-04 | |
|---|---|---|---|
| SAE Grade | 5w40 | Limits | Result |
| Absolute viscosity increase at | 4.66 | 8.74 | PASS |
| 100° C. and 6% of soot (cSt) | | | |

The value of the viscosity percentage increase, at 6% of soot, obtained in the motor engine test, shows that the lubricant oil formulated with the dispersant object of the present invention, brilliantly passes the standard engine test, demonstrating the efficacy of the polyalkenyl succinimide used.

1. (canceled)

2. A process for production of polyalkenyl succinimides comprising:
a. reacting at least one reactive polyalkene having a number average molecular weight, Mn, of from 1,300 to 6,000 and a content of terminal vinylidene groups higher than or equal to 30%, with at least one enophile selected from the group consisting of maleic anhydride and maleic acid, at a temperature higher than 180° C.;
b. carrying out the reaction thermally for a time sufficient for having a conversion of the terminal vinylidene groups higher than 10%;
c. completing the thermal reaction in the presence of a reaction accelerator which is a Lewis acid and is at least one metal halide selected from the group consisting of a tin, zinc, aluminium and titanium halide having the formula MX_{y}, wherein M is the metal, X represents a halide selected from the group consisting of chlorine, bromine, and iodine, wherein Xs may be the same or different, and y varies from 2 to 4, thereby obtaining the polyalkenyl succinanhydrides; and
d. reacting the polyalkenyl succinanhydrides obtained in (c) with at least one amine, at least one polyamine, or a mixture thereof, which has at least one primary amino group which forms an imide group,
wherein the polyalkenyl succinimides are derived from polyalkenyl succinanhydrides with a functionalization degree higher than 1.0 or a FD_{NMR} of from 1 to 2.

3. The process according to claim 2, wherein the at least one reactive polyalkene is a reactive homopolymer of a α-olefin or a α-olefin copolymer.

4. The process according to claim 3, wherein the at least one reactive polyalkene is polyisobutene (PIB), polybutene-1, or a combination thereof having a content of terminal vinylidene groups of at least 45% and a number average molecular weight of from 1,900 to 2,400.

5. The process according to claim 2, wherein the reaction between the at least one reactive polyalkene and the at least one enophile takes place at a temperature of from 180 to 300° C., at atmospheric pressure or under a pressure of inert gas of from 0.1 to 1 MPa.

6. The process according to claim 2, wherein a mole ratio of the at least one reactive polyalkylene to the at least one enophile is from 1:0.9 to 1:3.

7. The process according to claim 2, wherein the reaction accelerator is added to the reaction mixture when the conversion of the terminal vinylidene groups of the at least one reactive polyalkene is from 20 to 90%.

8. The process according to claim 2, wherein the accelerator is added to the reaction mixture in quantities corresponding to a molar percentage concentration, referring to the reactive double bonds of the polyalkene, of from 0.2 to 1.5%.

9. The process according to claim 2, wherein the metallic halide MX_{y} comprises a number of crystallization water molecules of from 1 to 5.

10. The process s according to claim 2, wherein said polyalkenyl succinanhydrides reacts with the at least one polyamine selected from the group consisting of polyamines represented by the formula
H₂N(CH₂CH₂NH)ₙH,
wherein n is an integer from 1 to 10.

11. The process according to claim 2, wherein the reaction between the polyalkenyl succinanhydride and the at least one polyamine takes place at a temperature of from 100 to 200° C.

12. The process according to claim 2, wherein the relative quantities of the maleic anhydride and the at least one polyamide are selected so that a ratio between the equivalents of succinic anhydride and the at least one polyamine is from 0.5 to 2.

13. The process according to claim 2, wherein M in the formula MX_{y} is tin.
